(19) United States
(12) Patent Application Publication
(10) Pub. No.: US 2016/0023851 A1
(43) Pub. Date: Jan. 28, 2016

(54) GRIPPER HEAD FOR REMOVING PACKAGES OF ARTICLES FROM A STACK

(71) Applicant: ATLANTIC C HANDELS- UND BERATUNGS GMBH, BERNKASTEL-KUES (DE)

(72) Inventor: ROLF GAENZ, BERNKASTEL-KUES (DE)

(21) Appl. No.: 14/874,646

(22) Filed: Oct. 5, 2015

Related U.S. Application Data
(63) Continuation of application No. PCT/EP2014/000827, filed on Mar. 27, 2014.

(30) Foreign Application Priority Data
Apr. 4, 2013 (DE) 102013005613.6

(51) Int. Cl. B65G 59/02; B25J 15/06; B65G 59/04; B25J 15/00

(52) U.S. Cl. CPC B65G 59/023; B25J 15/0014; B25J 15/0616; B25J 15/0052; B65G 59/04

(57) ABSTRACT

A gripper head for transporting packages of articles includes a suction nozzle having a suction opening for attachment to a package side wall by suction. The suction opening extends in a vertical plane in a loading position of the gripper head. At least one carrying element can be passed under a package bottom and longitudinally displaced in a horizontal plane in the loading position of the gripper head. A device tilts the package of articles from the loading position into a gripping position. A suction tube, which is provided in addition to the suction nozzle, is configured to be pivoted out in a direction of the package of articles and is movable transversely across a width of the gripper head.

### CROSS-REFERENCE TO RELATED APPLICATION

This is a continuation, under 35 U.S.C. §120, of copending International Application PCT/EP2014/000827, filed Mar. 27, 2014, which designated the United States; this application also claims the priority, under 35 U.S.C. §119, of German Patent Application DE 10 2013 005 613.6, filed Apr. 4, 2013; the prior applications are herewith incorporated by reference in their entirety.

### BACKGROUND OF THE INVENTION

### Field of the Invention

The present invention relates to a gripper head for removing packages of articles from stacks or from rack bays or the like.

The prior art discloses so-called suction grippers, which are attached by suction to the top surface of the package of articles by way of negative pressure and retain the package by way of negative pressure. Such suction grippers function as a rule only in the case of articles with continuous top surfaces, but not in the case of trays or drawers or similarly open loading aids.

Also known are so-called roll-on grippers. The roll-on grippers have a plurality of generally fork-like protrusions by way of which they pass partially under the package of articles. With the aid of belt conveyors attached to the protrusions, the article is conveyed onto the protrusions until the protrusions engage under the article in a mechanically secure manner. A disadvantage in that case is the fact that a roll-on gripper always requires a counter-stop because otherwise it would push the article to be loaded in front of it, with the consequence that the protrusions could engage under the article. The roll-on gripper requires a certain contact pressure in order to be able to lift and load an article by rolling friction.

German Patent Application DE 10 2007 054 867 A1 discloses a further suction gripper, in which the package is first of all acquired by suction by a suction apparatus and is initially tilted out of its standing position and subsequently has mechanical carrying elements passed under it. Similar constructions are shown in UK Patent Application GB 2 231 020 A and German Patent Application DE 44 27 488 A1.

### SUMMARY OF THE INVENTION

It is accordingly an object of the invention to provide a gripper head for removing packages of articles from a stack, which overcomes the hereinafore-mentioned disadvantages of the heretofore-known devices of this general type and which is improved with regard to an attachment of its suction devices to the package of articles.

In order to achieve this object, there is proposed a gripper head which first of all has a suction nozzle and a longitudinally displaceable carrying element, wherein the suction nozzle and the carrying element are disposed approximately at right angles to one another. In the loading position of the gripper head, the suction opening in the suction nozzle extends in a vertical plane. The carrying element consequently extends in a horizontal plane in this loading position. Furthermore, the gripper head has a pivoting device. With the aid of this pivoting device, the gripper head can tilt the package from its loading position into a gripping position. In this tilted position, the suction opening is pivoted out of its vertical plane and the carrying element is pivoted out of its horizontal plane, preferably by 5°-25°.

In addition to the suction nozzle, one or more suction tube(s) is/are provided on the gripper head. Such suction tubes can be attached to a peripheral side of the gripper head in order to flank the package of articles in that a further package side wall is subjected to negative pressure in addition to the package side wall subjected to negative pressure by the suction nozzle. It is also possible to place a suction tube in a displaceable manner on the gripper head. In this connection, it is particularly advantageous to configure a suction tube in the manner of a double-acting suction strip. This double-acting suction tube can then be displaced along the gripper head in such a way that it acts, together with the main suction strip of the gripper head, on one of the sides of the package in each case.

In one development of the invention, the suction nozzle acts as a pivoting device on the gripper head. The suction nozzle is pivotable to this end. The pivotability of the suction nozzle can be realized by an inherently flexible suction nozzle. The suction nozzle can be inherently flexible by way of combined lever and spring elements in such a way that it can tilt the package of articles to such an extent that the carrying element can move under the package of articles.

A further variant is formed of a suction nozzle mounted pivotably on the gripper head. The suction nozzle can tilt the package of articles, already acquired by suction, with respect to the gripper head in such a way that the carrying element can easily pass under the package of articles.

Alternatively to a pivotable suction nozzle, a suction nozzle is proposed that is vertically displaceable on the gripper head. The suction nozzle thus acquires the package of articles by suction and, by moving vertically in a travel direction, again effects the tilting of the package of articles in order to be passed under by the carrying element.

In a further alternative embodiment, it is also possible to mount the gripper head in a pivotable manner as a whole, in order to realize the tilting of the package of articles in this way.

It is also conceivable to realize mixed forms of the possible configurations of the pivoting device that are listed above. With the aid of this gripper head, it is possible first of all to move the gripper head in its loading position up to the package of articles. In the loading position, the suction nozzle, with its suction opening extending in the vertical plane, bears against a package side wall and in this way acquires the package by suction by way of the negative pressure exerted by the suction nozzle. As a result of the gripper head being lifted and simultaneously pivoted, the package is lifted at its side facing the gripper head and continues to stand on its standing surface with its edge facing away from the gripper head. A clearance, into which the carrying element attached to the gripper head in a longitudinally displaceable manner can travel, is thus created between the standing surface and the package bottom. The package can also be pulled out a little in the direction of the gripper head in this case. This carrying element is preferably formed by two or more fork-like protrusions or by a continuous tray. As soon as the carrying element has been extended fully in the longitudinal direction and in this way engages fully or largely under the package bottom, the tilted gripper head is moved back from its gripping position into its loading position, in which the plane of the suction opening of the suction nozzle extends vertically and the carrying element extends substantially horizontally. In an advantageous configuration, the extension path of the carrying element in the longitudinal direction and the setting angle of the gripper head are coordinated with the corresponding package length in a program-controlled manner. The package of articles resting on the carrying element is “picked” for example on a pallet from a rack or from a stack and is moved to its destination. In this case, the suction nozzle can perform a double function, specifically as a lifting aid in the gripping position of the gripper head on one hand and for load securing of the package of articles in the loading position on the other hand. In the loading position, the package of articles is held, in addition to the carrying element, by the negative pressure of the suction nozzle during the loading operation.

It is advantageous to use a position detection system for the apparatus. This position detection system serves to determine the exact position of the package and to synchronize this position with the gripping position of the gripper head.

A configuration of the gripper head with a rigid carrying element and a gripper head that is movable back and forth on the carrying element or a telescopically extendable suction tube is also conceivable. In this embodiment, in order to acquire the package by suction, the gripper head or the suction tube is moved up to the front edge of the carrying element in order to establish suction contact with the package of articles in this way. Following the lifting and simultaneous pivoting of the gripper head, the package is then pulled as it were onto the carrying element by a return movement of the gripper head or of the suction tube telescope. Subsequently, the gripper head and carrying element are moved back from the gripping position into the loading position.

In an advantageous configuration, a suction strip extends as the suction nozzle across the entire width of the gripper head. Such a suction strip affords a correspondingly large suction area extending across the entire package of articles and can accordingly exert a high suction force. Such suction strips are generally formed of a multiplicity of suction openings disposed alongside one another. These suction openings can be opened and closed by way of nonreturn valves, screens or comparable devices. This opening and closing can also take place automatically. This ensures that those openings in the suction strip that cover the side wall of the package are activated. This effectively prevents openings that are not covered by the package from sucking in relatively large amounts of ambient air.

The carrying element can be configured in a fork-like manner. In this case, the longitudinally displaceable protrusions form as it were the tines of a fork.

In a further configuration, it is also possible to provide a continuous tray as the carrying apparatus. Such a tray has the advantage of being able to bear particularly high forces and thus loads.

Other features which are considered as characteristic for the invention are set forth in the appended claims.

Although the invention is illustrated and described herein as embodied in a gripper head for removing packages of articles from a stack, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, side-elevational view of a gripper head, moved up to a package of articles, in a loading position during an acquisition of a package side wall by suction;

FIG. 2 is a side-elevational view showing the acquisition by suction and tilting of the package into a gripping position, including lifting of a suction strip;

FIG. 3 is a side-elevational view showing a passing of a carrying element under the package in the gripping position;

FIG. 4 is a side-elevational view showing the gripper head, loaded with the package and moved back from the gripping position into the loading position;

FIG. 5 is a plan view of a gripper head with a suction tube provided in addition to a suction nozzle; and

FIGS. 6A, 6B and 6C are side-elevational views showing a diagrammatic illustration of a suction nozzle, movable vertically on the gripper head, for tilting the package of articles in three functional positions.

### DETAILED DESCRIPTION OF THE INVENTION

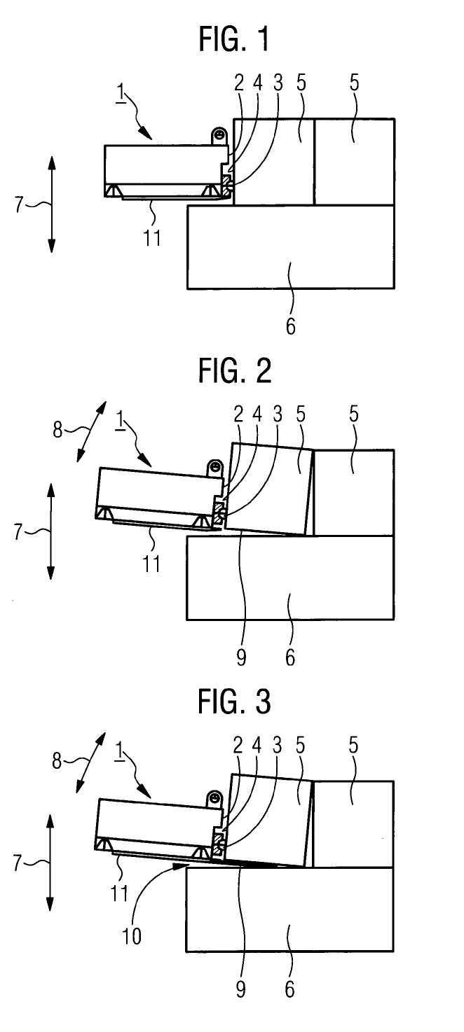

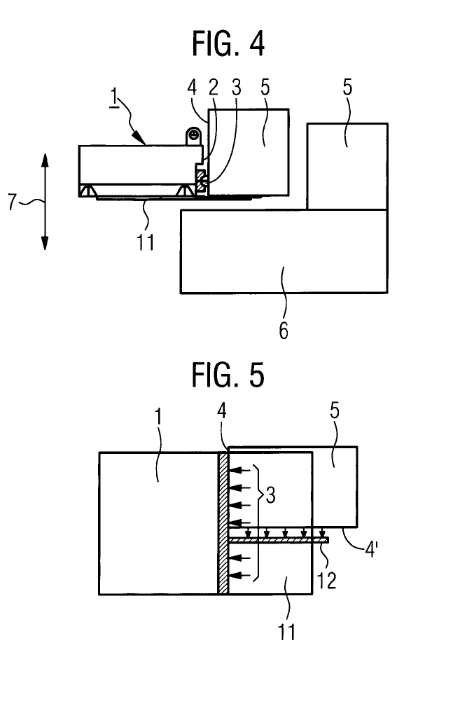

Referring now to the figures of the drawings in detail and first, particularly, to FIG. 1 thereof, there is seen a gripper head 1 having a suction nozzle 3 at its front side 2. In its loading position, illustrated in FIG. 1, the gripper head 1 moves with the suction nozzle 3 up to a package side wall 4 of a package of articles 5. In this exemplary embodiment the package of articles 5 stands on a partially illustrated pallet 6. FIG. 2 shows that the gripper head 1 is lifted in a travel direction 7 and pivoted in a pivoting direction 8 out of the loading position illustrated in FIG. 1 and into a gripping position illustrated in FIG. 2. Due to this pivoting into the gripping position and as a result of a small travel movement of the suction nozzle 3 in the travel direction 7 relative to the gripper head 1, the package of articles 5 acquired by suction by the suction nozzle 3 is lifted to such an extent on the side facing the gripper head 1 that a clearance 10 is left free between the pallet 6 and a package bottom 9 as seen in FIG. 3. A longitudinally displaceable carrying element 11, configured as a tray in the exemplary embodiment, travels into the clearance 10. The carrying element 11 engages in this case at least predominantly under the package bottom 9. Once the carrying element 11 has been pivoted back counter to the pivoting direction 8 into the horizontal position, both the package bottom 9 and the carrying element 11 are back in a horizontal plane, but lifted in the travel direction 7 from the pallet 6, as seen in FIG. 4. The package of articles 5, retained by the negative pressure exerted by the suction nozzle 3 and by the frictional forces of the carrying element 11, can then be moved to its destination.

If the illustrations in FIG. 1 and FIG. 2 are compared, it can be seen that the suction nozzle 3 in FIG. 1 adjoins the bottom edge of the gripper head 1 and, as it were, the carrying element 11, while in FIG. 2, the suction nozzle 3 has been moved upwards in the travel direction 7 with respect to the bottom edge of the gripper head 1 and the carrying element 11. This vertical movability of the suction nozzle 3 on the gripper head 1 serves to equalize the difference in height between the bottom edge of the package of articles 5 on one hand and of the carrying element 11 on the other hand.

At the destination, the carrying element 11 is positioned over a deposition surface in such a way that the carrying element 11, together with the package of articles 5, virtually rests on the carrier at the destination. Then, the negative pressure at the suction nozzle 3 is switched off and the carrying element 11 is retracted. As soon as the carrying element 11 has been fully retracted, the unloading operation is completed.

It can be seen from FIG. 5 that an additional suction tube 12 is formed on the gripper head 1 in addition to the strip-like suction nozzle 3 which is formed on the gripper head 1 and has a plurality of suction openings that are closable for example by way of nonreturn valves. The suction tube 12 additionally acts on the package side wall 4′ of the package of articles 5 which is illustrated in FIG. 5 as being positioned in the longitudinal direction on the carrying element 11. This means that the package of articles 5 is not only retained by way of negative pressure by the suction nozzle 3 at its package side wall 4 which faces the gripper head 1. In addition, the further package side wall 4′ is subjected to negative pressure by the suction tube 12.

The suction tube 12 in the exemplary embodiment has suction openings on both sides, although only the suction openings facing the package of articles 5 are activated. In this way, it is possible to subject both sides of the package of articles 5 to additional negative pressure by way of the suction tube 12. If the suction tube 12 is not required, it can be pivoted away upwardly.

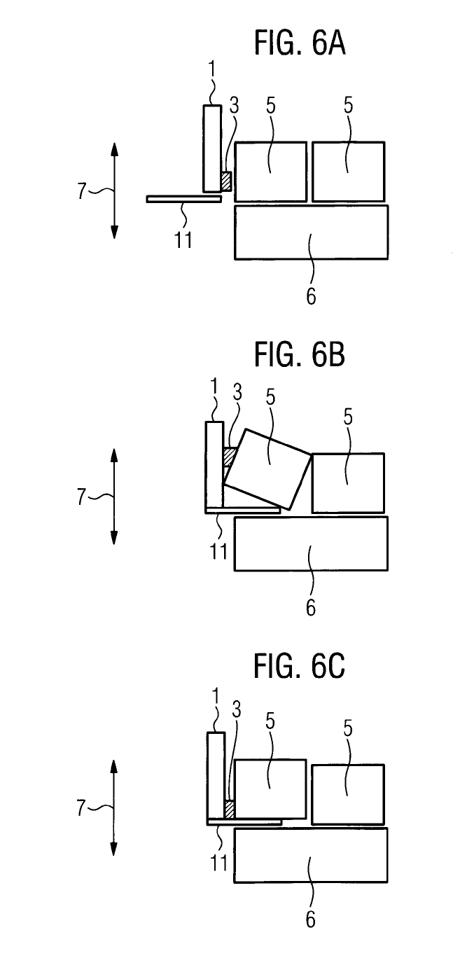

FIG. 6A diagrammatically illustrates the gripper head 1, the carrying element 11 and the package of articles 5. The suction nozzle 3, which is movable vertically in the travel direction 7, is fixed to the gripper head 1. In FIG. 6A, the gripper head 1 is moved up to the package of articles 5 in such a way that the suction nozzle 3 can attach itself firmly to the side wall, facing it, of the package of articles 5.

In FIG. 6B, the suction nozzle 3 moves upwardly in the travel direction 7 along the gripper head 1 in such a way that the package of articles 5 is tilted with respect to its starting position shown in FIG. 6A. Due to this tilting, the carrying element 11 can pass under the package of articles 5. As soon as the carrying element 11 has passed fully under the package of articles 5, the suction nozzle 3 on the gripper head 1 is moved back into its starting position in the travel direction 7, so that the package of articles 5, as shown in FIG. 6C, rests on the carrying element 11 and is additionally retained by the suction nozzle 3. It is apparent from viewing FIGS. 6A, 6B and 6C that the same effect as in FIG. 6B, with the suction nozzle 3 being movable in the travel direction 7, can be achieved in that the entire gripper head 1 is tipped with respect to the package of articles 5, as is illustrated in FIG. 2, or the suction nozzle 3 is configured to be pivotable relative to the gripper head 1.

1. A gripper head for transporting packages of articles, the gripper head comprising:
a suction nozzle having a suction opening for attachment to a package side wall by suction, said suction opening extending in a vertical plane in a loading position of the gripper head;
at least one carrying element to be passed under a package bottom, said at least one carrying element being longitudinally displaceable in a horizontal plane in said loading position of the gripper head;
a device for tilting the package of articles from said loading position into a gripping position; and
a suction tube provided in addition to said suction nozzle, said suction tube being configured to be pivoted out in a direction of the package of articles and being movable transversely across a width of the gripper head.

2. The gripper head according to claim 1, wherein said suction nozzle is pivotable for tilting the package of articles.

3. The gripper head according to claim 2, wherein said suction nozzle is mounted on the gripper head in a vertically displaceable manner in a travel direction of the gripper head.

4. The gripper head according to claim 1, wherein said gripper head is mounted in a pivotable manner in order to be tilted.

5. The gripper head according to claim 1, wherein said suction nozzle is a suction strip extending across an entire width of the gripper head.

6. The gripper head according to claim 1, wherein said suction tube is angularly adjustable.
